(19) United States
(12) Patent Application Publication
(10) Pub. No.: US 2026/0181455 A1
(43) Pub. Date: Jun. 25, 2026

(54) MEASUREMENT PREDICTION CONTROL METHOD AND APPARATUS

(71) Applicant: ELECTRONICS AND TELECOMMUNICATIONS RESEARCH INSTITUTE, Daejeon (KR)

(72) Inventors: Hyun Seo PARK, Daejeon (KR); Yong Jin KWON, Daejeon (KR); Yunjoo KIM, Daejeon (KR); Seungjae BAHNG, Daejeon (KR); Jungbo SON, Daejeon (KR); Youngjoon YOON, Daejeon (KR); Anseok LEE, Daejeon (KR); Yu Ro LEE, Daejeon (KR); Jungsook BAE, Daejeon (KR); Heesoo LEE, Daejeon (KR)

(73) Assignee: ELECTRONICS AND TELECOMMUNICATIONS RESEARCH INSTITUTE, Daejeon (KR)

(21) Appl. No.: 19/421,724

(22) Filed: Dec. 16, 2025

(30) Foreign Application Priority Data
Dec. 17, 2024 (KR) 10-2024-0188472
Jul. 1, 2025 (KR) 10-2025-0087769
Dec. 15, 2025 (KR) 10-2025-0199625

(51) Int. Cl. H04W 24/10; H04B 17/373

(52) U.S. Cl. CPC H04W 24/10; H04B 17/373

(57) ABSTRACT

A method of a terminal may comprise: receiving measurement configuration information from a base station; receiving, from the base station, a measurement trigger for cells indicated by the measurement configuration information; performing measurement on the cells based on the measurement trigger; and transmitting, to the base station, a measurement report based on the measurement.

### CROSS-REFERENCE TO RELATED APPLICATIONS

This application claims priority to Korean Patent Applications No. 10-2024-0188472, filed on Dec. 17, 2024, No. 10-2025-0087769, filed on Jul. 1, 2025, and No. 10-2025-0199625, filed on Dec. 15, 2025, with the Korean Intellectual Property Office (KIPO), the entire contents of which are hereby incorporated by reference.

### BACKGROUND

### 1. Technical Field

The present disclosure relates to an enhanced communication technique, and more particularly, to a technique for controlling measurement prediction.

### 2. Related Art

A communication network (e.g. 5G communication network, 6G communication network, and the like) for providing improved communication services compared to an existing communication network (e.g. long term evolution (LTE), LTE Advanced (LTE-A), and the like) is being developed. The 5G communication network (e.g. new radio (NR) communication network) can support frequency bands of 6 GHz or lower as well as frequency bands above 6 GHz. In other words, the 5G communication network can support frequency range 1 (FR1) and/or frequency range 2 (FR2). The 5G communication network can support various communication services and scenarios compared to the LTE communication network. For example, usage scenarios of the 5G communication network may include enhanced Mobile Broadband (eMBB), Ultra-Reliable Low Latency Communication (URLLC), and massive Machine Type Communication (mMTC).

A terminal may measure strengths (or qualities) of signals received from a serving cell and neighboring cells under control of a base station. The terminal may report the strengths of the received signals to the base station. The base station may generate configuration information for mobility management of the terminal, carrier aggregation (CA), dual connectivity, or load balancing based on the reported signal strengths. The base station may transmit the determined configuration information to the terminal to perform radio resource control (RRC) configuration (or reconfiguration) for the terminal. However, repeated measurements by the terminal may cause various problems. For example, the repeated measurements by the terminal may increase power consumption of the terminal.

The base station may transmit measurement gap configuration information to the terminal. The base station may not perform scheduling for the terminal during a measurement gap. Accordingly, a user-perceived throughput may be reduced.

### SUMMARY

The present disclosure for resolving the above-described problems is directed to providing methods and apparatuses for controlling measurement prediction.

A method of a terminal, according to exemplary embodiments of the present disclosure, may comprise: receiving measurement configuration information from a base station; receiving, from the base station, a measurement trigger for cells indicated by the measurement configuration information; performing measurement on the cells based on the measurement trigger; and transmitting, to the base station, a measurement report based on the measurement.

The measurement trigger may include first information for measurement on the cells, the measurement is performed according to the first information, and the measurement report may include measurement results based on the measurement.

The measurement configuration information may include measurement gap configuration information, the measurement gap configuration information may include at least one of a measurement gap repetition period or a measurement gap length, measurement gaps configured by the measurement gap configuration information may enter an active state based on reception of the measurement trigger, the measurement may be performed during time durations corresponding to the measurement gaps, and the measurement gaps may enter an inactive state based on completion of the measurement.

The measurement configuration information may include configuration information for a cluster including the cells, and the cluster may include at least one of a serving cell of the terminal or neighboring cells of the terminal.

The measurement configuration information may include configuration information for configuring the terminal to transmit the measurement report based on reception of the measurement trigger.

The method may further comprise: after performing the measurement, performing a comparison between measurement prediction results included in the measurement trigger and measurement results based on the measurement, wherein the measurement report may be transmitted based on the comparison.

The measurement configuration information may include configuration information for configuring the terminal to transmit the measurement report based on a comparison between measurement prediction results included in the measurement trigger and measurement results, the comparison being performed based on reception of the measurement trigger.

The measurement report may be transmitted based on a difference value between the measurement prediction results included in the measurement trigger and the measurement results being equal to or greater than a threshold, and the measurement trigger may include the threshold.

The measurement report may not include the measurement results, based on a difference value between the measurement prediction results included in the measurement trigger and the measurement results being equal to or less than a threshold, and the measurement report may include a flag indicating that the difference value is equal to or less than the threshold.

The measurement report may include measurement results based on the measurement, and may include location information of the terminal according to the measurement configuration information.

A method of a base station, according to exemplary embodiments of the present disclosure, may comprise: transmitting measurement configuration information to a terminal; performing measurement prediction for cells indicated by the measurement configuration information; transmitting, to the terminal, a measurement trigger including measurement prediction results based on the measurement prediction; and receiving, from the terminal, a measurement report in response to the measurement trigger.

The measurement trigger may include first information for measurement on the cells, the measurement may be performed by the terminal according to the first information, and the measurement report may include measurement results based on the measurement.

The measurement configuration information may include configuration information for configuring the terminal to transmit the measurement report based on reception of the measurement trigger.

The measurement configuration information may include configuration information for configuring the terminal to transmit the measurement report based on a comparison between the measurement prediction results and measurement results, the comparison being performed based on reception of the measurement trigger.

The measurement report may be transmitted from the terminal based on a difference value between the measurement prediction results and measurement results based on measurement performed by the terminal being equal to or greater than a threshold, and the measurement trigger may include the threshold.

The measurement report may not include measurement results, based on a difference value between the measurement prediction results and measurement results based on measurement performed by the terminal being equal to or less than a threshold, and the measurement report may include a flag indicating that the difference value is equal to or less than the threshold.

The measurement configuration information may include configuration information for configuring the terminal to transmit the measurement report according to a comparison between the measurement prediction results and measurement results, the comparison being performed based on reception of the measurement trigger.

The measurement report may include measurement results based on measurement performed by the terminal, and may include location information of the terminal according to the measurement configuration information.

A terminal according to exemplary embodiments of the present disclosure may comprise at least one processor, and the at least one processor may cause the terminal to perform: receiving measurement configuration information from a base station; receiving, from the base station, a measurement trigger for cells indicated by the measurement configuration information; performing measurement on the cells based on the measurement trigger; and transmitting, to the base station, a measurement report based on the measurement.

The measurement trigger may include first information for measurement on the cells, the measurement may be performed according to the first information, and the measurement report may include measurement results based on the measurement.

According to the present disclosure, a terminal is not required to always maintain measurement gaps configured by the base station in an activated state. Accordingly, unnecessary power consumption can be reduced, and the user-perceived throughput can be increased.

### BRIEF DESCRIPTION OF DRAWINGS

FIG. 1 is a conceptual diagram illustrating exemplary embodiments of a communication system.

FIG. 2 is a block diagram illustrating exemplary embodiments of a communication node constituting a communication system.

FIG. 3 is a sequence diagram illustrating exemplary embodiments of a measurement reporting procedure.

FIG. 4 is a sequence diagram illustrating exemplary embodiments of a measurement reporting procedure.

FIG. 5 is a sequence diagram illustrating exemplary embodiments of a measurement reporting procedure.

FIG. 6 is a sequence diagram illustrating exemplary embodiments of a measurement prediction reporting procedure.

FIG. 7 is a sequence diagram illustrating exemplary embodiments of a measurement rate reduction ratio update request procedure.

FIG. 8 is a sequence diagram illustrating exemplary embodiments of a measurement rate reduction ratio update procedure.

FIG. 9 is a sequence diagram illustrating exemplary embodiments of a UE assistance information transmission procedure.

FIG. 10 is a conceptual diagram illustrating exemplary embodiments of functional blocks included in a terminal.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the present disclosure, ‘(re) transmission’ may refer to ‘transmission’, ‘retransmission’, or ‘transmission and retransmission’, ‘(re) configuration’ may refer to ‘configuration’, ‘reconfiguration’, or ‘configuration and reconfiguration’, ‘(re) connection’ may refer to ‘connection’, ‘reconnection’, or ‘connection and reconnection’, and ‘(re) access’ may refer to ‘access’, ‘re-access’, or ‘access and re-access’.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in detail with reference to the accompanying drawings. In describing the disclosure, to facilitate the entire understanding of the disclosure, like numbers refer to like elements throughout the description of the figures and the repetitive description thereof will be omitted.

A communication network (or communication system) to which exemplary embodiments according to the present disclosure are applied will be described. The communication network to which exemplary embodiments according to the present disclosure are applied is not limited to the content described below, and the exemplary embodiments according to the present disclosure can be applied to various communication networks. Here, the term ‘communication network’ may be used interchangeably with ‘communication system’. The communication network may refer to a wireless communication network, and the communication system may refer to a wireless communication system.

In the present disclosure, ‘configuration of an operation (e.g. transmission operation)’ may refer to signaling of configuration information (e.g. information elements, parameters) required for the operation and/or information indicating to perform the operation. ‘configuration of information elements (e.g. parameters)’ may refer to signaling of the information elements. In the present disclosure, signaling may be at least one of System Information (SI) signaling (e.g. transmission of System Information Block (SIB) and/or Master Information Block (MIB)), RRC signaling (e.g. transmission of RRC parameters and/or higher-layer parameters), MAC Control Element (CE) signaling, or PHY signaling (e.g. transmission of Downlink Control Information (DCI), Uplink Control Information (UCI), and/or Sidelink Control Information (SCI).

The names of frames proposed in the present disclosure may be generalized as a first frame, a second frame, a third frame, and the like. In the present disclosure, a transmission time may refer to a start time of frame transmission and/or an end time (e.g. completion time) of frame transmission, while a reception time may refer to a start time of frame reception and/or an end time (e.g. completion time) of frame reception. The term ‘time’ may be interpreted as a time point depending on a context.

In the present disclosure, a phrase including “when ˜” may be expressed as a phrase including “based on ˜” or a phrase including “in response to ˜”. In other words, a phrase including “when ˜” may be interpreted as being the same as or similar to a phrase including “based on ˜” or a phrase including “in response to ˜”.

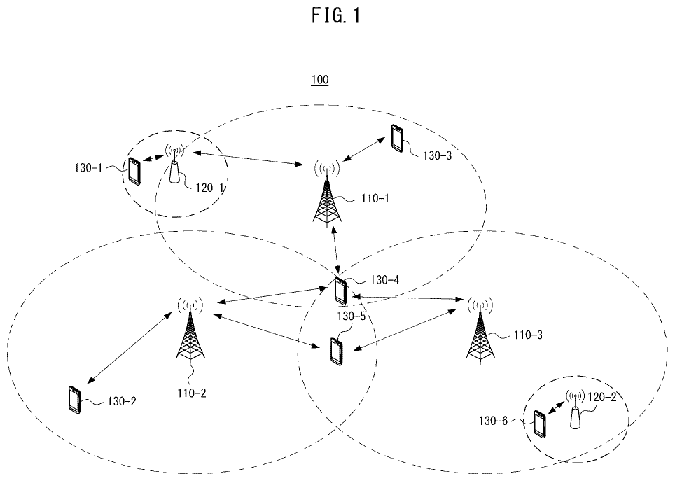

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Also, the communication system 100 may further comprise a core network (e.g. a serving gateway (S-GW), a packet data network (PDN) gateway (P-GW), and a mobility management entity (MME)). When the communication system 100 is a 5G communication system (e.g. New Radio (NR) system), the core network may include an access and mobility management function (AMF), a user plane function (UPF), a session management function (SMF), and the like.

The plurality of communication nodes 110 to 130 may support communication protocols defined in the 3rd generation partnership project (3GPP) technical specifications (e.g. LTE communication protocol, LTE-A communication protocol, NR communication protocol, or the like). The plurality of communication nodes 110 to 130 may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform-spread-OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter band multi-carrier (FBMC) based communication protocol, universal filtered multi-carrier (UFMC) based communication protocol, space division multiple access (SDMA) based communication protocol, or the like. Each of the plurality of communication nodes may have a structure below.

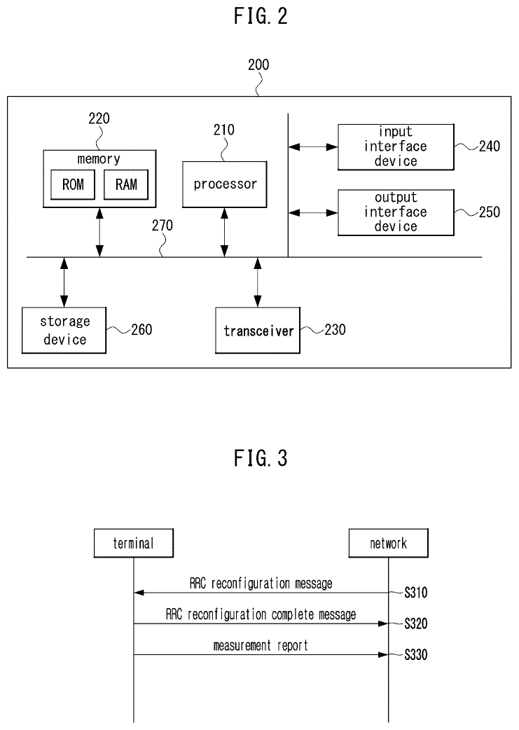

FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. The respective components included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to the cell coverage of the first base station 110-1. Also, the second terminal 130-2, the fourth terminal 130-4, and the fifth terminal 130-5 may belong to the cell coverage of the second base station 110-2. Also, the fifth base station 120-2, the fourth terminal 130-4, the fifth terminal 130-5, and the sixth terminal 130-6 may belong to the cell coverage of the third base station 110-3. Also, the first terminal 130-1 may belong to the cell coverage of the fourth base station 120-1, and the sixth terminal 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), gNB, advanced base station (ABS), high reliability-base station (HR-BS), base transceiver station (BTS), radio base station, radio transceiver, access point (AP), access node, radio access station (RAS), mobile multi-hop relay-base station (MMR-BS), relay station (RS), advanced relay station (ARS), high reliability-relay station (HR-RS), home NodeB (HNB), home eNodeB (HeNB), road side unit (RSU), radio remote head (RRH), transmission point (TP), transmission and reception point (TRP), or the like.

Each of the plurality of terminals 130-1, 130-2, 130-3, 130-4, 130-5, and 130-6 may be referred to as user equipment (UE), terminal equipment (TE), advanced mobile station (AMS), high reliability-mobile station (HR-MS), terminal, access terminal, mobile terminal, station, subscriber station, mobile station, portable subscriber station, node, device, on-board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support a multi-input multi-output (MIMO) transmission (e.g. single-user MIMO (SU-MIMO), multi-user MIMO (MU-MIMO), massive MIMO, or the like), a coordinated multipoint (CoMP) transmission, a carrier aggregation (CA) transmission, a transmission in unlicensed band, a device-to-device (D2D) communication (or, proximity services (ProSe)), an Internet of Things (IoT) communication, a dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e. the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

Each of the first base station 110-1, the second base station 110-2, and the third base station 110-3 may transmit a signal to the fourth terminal 130-4 in the COMP transmission manner, and the fourth terminal 130-4 may receive the signal from the first base station 110-1, the second base station 110-2, and the third base station 110-3 in the COMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, operation methods of a communication node in a communication network will be described. Even when a method (e.g. transmission or reception of a signal) to be performed at a first communication node among communication nodes is described, a corresponding second communication node may perform a method (e.g. reception or transmission of the signal) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

### [Control of Terminal Measurement]

A terminal may perform measurements on a serving cell and neighboring cells based on control of a base station. The measurements on the serving cell and the neighboring cells may include measurements of strengths (or qualities) of signals received from the serving cell and the neighboring cells. The terminal may transmit a measurement report to the base station after performing the measurement on the serving cell and the neighboring cells. The base station may determine configuration information related to mobility management of the terminal (e.g. handover, cell switching), CA configuration, dual connectivity configuration, or cell reallocation for load balancing based on the measurement report. The base station may transmit the determined configuration information to the terminal through an RRC reconfiguration message.

The terminal may perform measurement on neighboring cells having the same center frequency as the center frequency of the serving cell (e.g. intra-frequency measurement), measurement on neighboring cells having different center frequencies (e.g. inter-frequency measurement), or measurement on cells belonging to a different radio access technology (e.g. inter-RAT measurement). When the terminal continuously performs the above-described measurement, battery consumption of the terminal may increase. The base station may configure a measurement gap for the terminal so that the terminal performs measurements, and the base station may suspend scheduling for the terminal during the measurement gap. Accordingly, a user-perceived throughput may decrease during the measurement gap may occur.

In order to solve the above-described problems, the present disclosure provides methods of determining whether a terminal performs an actual signal strength measurement based on a signal strength measurement prediction result determined by a network or methods of controlling cells to be measured. The present disclosure proposes methods of dynamically adjusting a time at which a signal strength measurement operation or a signal strength measurement prediction operation is performed, a frequency of performance, and a measurement scheme, based on signal strength measurement results reported from a terminal or signal strength measurement prediction results determined by a network.

According to the above-described methods, a signal strength measurement operation of the terminal can be controlled to be performed only to a necessary extent within a range satisfying quality of service requirements. Battery consumption due to unnecessary measurement can be reduced. A number of measurement gaps can be reduced. Since scheduling can be performed during the measurement gaps, a user-perceived throughput may be improved.

FIG. 3 is a sequence diagram illustrating exemplary embodiments of a measurement reporting procedure.

Referring to FIG. 3, a base station may determine measurement configuration information based on capability information of a terminal. The base station may transmit, to the terminal, an RRC reconfiguration message including the measurement configuration information (S310). The terminal may perform measurement configuration according to the measurement configuration information after receiving the RRC reconfiguration message. The measurement configuration may include configuration of conditions used for measurements by the terminal (e.g. measurement target cells, reporting conditions, and measurement events). The terminal may transmit an RRC reconfiguration complete message to the base station after completing the measurement configuration (S320).

The terminal may perform measurements based on updated conditions (e.g. occurrence of a measurement event, a measurement periodicity) according to the measurement configuration. The terminal may transmit a measurement report including measurement results (e.g. signal strength measurement results) to the base station (S330).

The measurement configuration information may be generated according to Tables 1 to 3. measObjectToRemoveList may indicate a list of measurement objects to be removed from measurement targets (e.g. cells or frequencies). measObjectToAddModList may indicate a list of measurement objects to be added to or modified in the measurement targets. reportConfigToRemoveList may indicate a list of measurement report configurations to be removed. reportConfigToAddModList may indicate a list for adding new measurement report configurations or modifying existing measurement report configurations. quantityConfig may indicate filter-related parameters such as coefficients of an L3 filter. measIdToRemoveList may indicate measurement identifiers to be removed from a measurement identifier list. measIdToAddModList may indicate measurement identifiers to be added to the measurement identifier list or measurement identifiers to be modified in the measurement identifier list. Based on s-MeasureConfig, the terminal may be configured not to perform neighboring cell measurements when a signal strength received from the serving cell is equal to or greater than a threshold.

TABLE 1
-- ASN1START
-- TAG-MEASCONFIG-START
MeasConfig ::= SEQUENCE {

| | | |
|---|---|---|
| measObjectToRemoveList | MeasObjectToRemoveList | OPTIONAL, -- Need N |
| measObjectToAddModList | MeasObjectToAddModList | OPTIONAL, -- Need N |
| reportConfigToRemoveList | ReportConfigToRemoveList | OPTIONAL, -- Need N |
| reportConfigToAddModList | ReportConfigToAddModList | OPTIONAL, -- Need N |
| measIdToRemoveList | MeasIdToRemoveList | OPTIONAL, -- Need N |
| measIdToAddModList | MeasIdToAddModList | OPTIONAL, -- Need N |

TABLE 2

| s-MeasureConfig | CHOICE { | |
|---|---|---|
| | ssb-RSRP, | |
| | csi-RSRP | |
| | } | OPTIONAL, -- Need N |
| quantityConfig | QuantityConfig | OPTIONAL, -- Need M |
| measGapConfig | MeasGapConfig | OPTIONAL, -- Need M |
| measGapSharingConfig | MeasGapSharingConfig | OPTIONAL, -- Need M |

...,

```
TABLE 3
  [[
      interFrequencyConfig-NoGap-r16 ENUMERATED {true} OPTIONAL -- Need R
    ]]
  }
  MeasObjectToRemoveList ::= SEQUENCE (SIZE (1..maxNrofObjectId)) OF MeasObjectId
  MeasIdToRemoveList ::= SEQUENCE (SIZE (1..maxNrofMeasId)) OF MeasId
  ReportConfigToRemoveList ::= SEQUENCE (SIZE (1..maxReportConfigId)) OF
ReportConfigId
-- TAG-MEASCONFIG-STOP
-- ASN1STOP
```

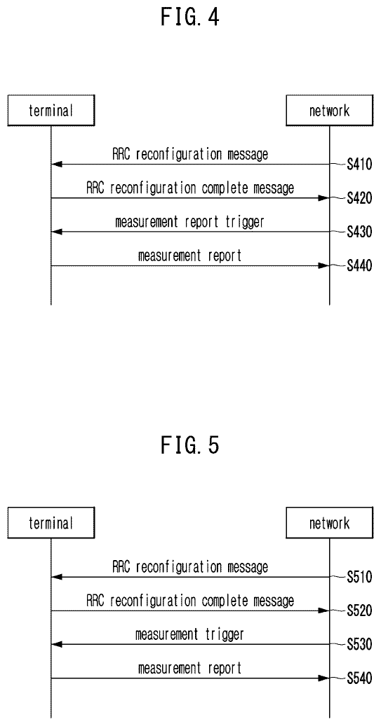

FIG. 4 is a sequence diagram illustrating exemplary embodiments of a measurement reporting procedure.

Referring to FIG. 4, a base station may determine measurement configuration information based on capability information of a terminal. The base station may transmit, to the terminal, an RRC reconfiguration message including the measurement configuration information (S410). The terminal may perform measurement configuration according to the measurement configuration information after receiving the RRC reconfiguration message. The measurement configuration may include configuration of conditions used for measurements of the terminal (e.g. measurement target cells, reporting conditions, and measurement events). The terminal may transmit an RRC reconfiguration complete message to the base station after completing the measurement configuration (S420).

The terminal may perform measurements based on updated conditions (e.g. occurrence of a measurement event, a measurement periodicity) according to the measurement configuration. The base station may determine whether measurement results (e.g. signal strength measurement results) are required. When the base station determines that the measurement results are required, the base station may transmit a measurement report trigger to the terminal (S430). The measurement report trigger may request the terminal to transmit the measurement results. The base station may configure, through the measurement configuration information, the terminal to transmit a measurement report when the terminal receives the measurement report trigger. Information used for configuring the terminal to transmit the measurement report upon receiving the measurement report trigger may be included in report configuration information. In another example, the base station may configure, through the measurement configuration information, the terminal to perform measurement immediately after completing signal strength measurement configuration and to transmit a measurement report including the corresponding signal strength measurement results to the base station. Information used when configuring the terminal to perform measurement immediately after completing the signal strength measurement configuration and to transmit the measurement report including the corresponding signal strength measurement results to the base station may be included in report configuration information.

The measurement report trigger may be transmitted through DCI, MAC CE, or an RRC message. The measurement report trigger may include a measurement identifier MeasID. In another example, the measurement report trigger may include a measurement object identifier MeasObjectID or a report configuration identifier ReportConfigID. The measurement identifier, the measurement object identifier MeasObjectID, or the report configuration identifier ReportConfigID may be configured by the measurement configuration information included in the RRC reconfiguration message.

The measurement report trigger may include information on neighboring cells for which reporting of signal strength measurement results is required. The information on the neighboring cells may be defined in units of a cluster. In other words, the information on the neighboring cells may be included in cluster configuration information. A cluster may include a serving cell. The cluster may include one or more neighboring cells. The information on the neighboring cells or the cluster configuration information may be included in report configuration information or measurement object information.

Upon receiving the measurement report trigger, the terminal may transmit a measurement report including measurement results to the base station (S440). The measurement report may be transmitted through an RRC message, MAC CE, or UCI. The measurement report may include a measurement identifier. When the measurement report trigger includes information on neighboring cells for which signal strength measurement results are required, the terminal may transmit, to the base station, a measurement report including signal strength measurement results for the above-described neighboring cells. The measurement report may include location information of the terminal according to configuration of the base station.

The above-described measurement reporting procedure may be applied not only to a layer 3 (L3) cell-level signal strength measurement and reporting procedure but also to a layer 1 (L1) beam-level signal strength measurement and reporting procedure.

FIG. 5 is a sequence diagram illustrating exemplary embodiments of a measurement reporting procedure.

Referring to FIG. 5, a base station may determine measurement configuration information based on capability information of a terminal. The base station may transmit, to the terminal, an RRC reconfiguration message including the measurement configuration information (S510). The measurement configuration information may include cluster configuration information. A cluster configured in the terminal by the cluster configuration information may include at least one of a serving cell of the terminal or neighboring cells of the terminal. The terminal may perform measurement configuration according to the measurement configuration information after receiving the RRC reconfiguration message. The measurement configuration may include configuration of conditions used for measurements of the terminal (e.g. measurement target cells, reporting conditions, measurement events). The terminal may transmit an RRC reconfiguration complete message to the base station after completing the measurement configuration (S520). The terminal may perform measurement based on updated conditions (e.g. occurrence of a measurement event, a measurement period) according to the measurement configuration.

The base station may configure a measurement gap for the terminal for an inter-frequency measurement or an inter-RAT measurement of the terminal. The base station may not perform scheduling for the terminal during the measurement gap. The base station may configure the measurement gap for the terminal through the measurement configuration information. The configuration of the measurement gap may include configuration of a measurement gap repetition period (MGRP) and a measurement gap length (MGL). For example, when the MGRP is set to 40 ms and the MGL is set to 6 ms, a measurement gap of 6 ms may be configured every 40 ms. The inter-frequency measurement or the inter-RAT measurement may be performed during the measurement gap of 6 m. The base station may not perform scheduling for the terminal during the measurement gap. The base station may not perform communication with the terminal during the measurement gap. Accordingly, a user-perceived throughput may decrease during the measurement gap.

A network (e.g. the base station or Operations, Administration and Maintenance (OAM)) may predict measurement results of the inter-frequency measurement or the inter-RAT measurement. The network may perform measurement prediction for cells indicated by the measurement configuration information. In another example, the network may perform measurement prediction for first cells among the cells indicated by the measurement configuration information. The first cells may be cells for which signal strength measurement is required by a measurement trigger. The first cells may belong to the cells indicated by the measurement configuration information. For accurate measurement prediction, the base station may receive, from the terminal, measurement results (e.g. signal strength measurement results) for the serving cell and the neighboring cells belonging to the cluster. The base station may predict measurement results of inter-frequency measurement or inter-RAT measurement based on the measurement results. Whether measurement prediction results (e.g. signal strength measurement prediction results) by the base station are accurate may need to be verified through comparison between measurement results of the terminal and the measurement prediction results. The base station may control measurement of the terminal based on the measurement prediction results.

The base station may determine whether measurement and/or measurement results of the terminal are required. When the base station determines that measurement and/or measurement results of the terminal are required, the base station may transmit a measurement trigger to the terminal (S530). The base station may request measurement from the terminal through the measurement trigger. The base station may request reporting of measurement results from the terminal through the measurement trigger. The measurement configuration information may include configuration information for configuring the terminal to transmit a measurement report based on reception of the measurement trigger. The measurement trigger may be transmitted through DCI, MAC CE, or an RRC message. The measurement trigger may include a measurement identifier MeasID. In another example, the measurement trigger may include a measurement object identifier MeasObjectID or a report configuration identifier ReportConfigID. The measurement identifier, the measurement object identifier, or the report configuration identifier included in the measurement trigger may be information for performing measurement on the cells indicated by the measurement configuration information. The terminal that receives the measurement trigger may perform measurement on the cells indicated by the measurement configuration information based on information for performing measurement on the cells. The measurement identifier, the measurement object identifier MeasObjectID, or the report configuration identifier may be configured by the measurement configuration information included in the RRC reconfiguration message. The measurement trigger may include signal strength measurement prediction results. The signal strength measurement prediction results may be generated by the base station. The measurement trigger may include information on neighboring cells for which signal strength measurement results are required.

The terminal may receive the measurement trigger from the base station. After receiving the measurement trigger, the terminal may perform measurement on measurement objects corresponding to the measurement identifier. The terminal may perform measurement during the measurement gap for inter-frequency measurement or inter-RAT measurement. In one example, an initial state of the measurement gap configured in the terminal by the measurement configuration information may be set to an inactive state. When the terminal receives the measurement trigger, the state of the measurement gap may transition to an active state. The terminal may perform measurement during the measurement gap. After completing the measurement, the terminal may request the base station to transition the state of the measurement gap to the inactive state. The state of the measurement gap may enter the inactive state when the measurement is completed. The terminal may request the base station to transition the state of the measurement gap to the inactive state through the measurement report or through a separate message.

In another example, the base station may transmit, to the terminal, a measurement trigger including a number of measurement gaps. The number of measurement gaps may correspond to time durations defined by the measurement gap configuration. The number of measurement gaps may refer to a number of repetitions of the measurement gap, or may refer to a time duration during which the measurement gap is repeated. When the terminal receives the measurement trigger from the base station, the measurement gap configured in the terminal may transition to the active state. When the terminal receives the measurement trigger and the measurement gap transitions to the active state, the terminal may perform measurements during the measurement gaps corresponding to the indicated number. When the measurement of the terminal is completed, the measurement gap may implicitly transition to the inactive state.

In another example, the base station may not configure a measurement gap in advance through the measurement configuration information. The base station may transmit, to the terminal, a measurement trigger including measurement gap configuration information. The terminal that receives the measurement trigger may perform measurement during a measurement gap. When the measurement of the terminal is completed, the measurement gap may implicitly transition to the inactive state.

The terminal that completes measurement based on the measurement trigger may transmit a measurement report including measurement results to the base station (S540). The measurement report may be transmitted through an RRC message, MAC CE, or UCI. The measurement report may include a measurement identifier. In another example, the measurement report may include a measurement object identifier or a report configuration identifier ReportConfigID. The measurement identifier, the measurement object identifier, or the report configuration identifier may be configured by the measurement configuration information included in the RRC reconfiguration message.

The measurement trigger may include signal strength measurement prediction results. When the measurement trigger includes the signal strength measurement prediction results, the terminal may transmit, to the base station, a measurement report including signal strength measurement results for neighboring cells associated with the signal strength measurement prediction results. When the measurement trigger includes information on neighboring cells for which signal strength measurement results are required, the terminal may transmit, to the base station, a measurement report including signal strength measurement results for the neighboring cells. The signal strength measurement prediction results may be signal strength measurement prediction results for cells indicated by the measurement configuration information. In another example, the signal strength measurement prediction results may be signal strength measurement prediction results for first cells for which signal strength measurement is required by the measurement trigger. The first cells may be included in the cells indicated by the measurement configuration information.

The base station may configure the terminal, through the measurement configuration information or the report configuration information, to perform measurement and to transmit a measurement report including signal strength measurement results when the terminal receives the measurement trigger.

In another example, when the terminal receives the measurement trigger, the terminal may perform measurement. After performing the measurement, the terminal may compare signal strength measurement results with the signal strength measurement prediction results included in the measurement trigger. The terminal may determine whether a difference value derived from a comparison result is equal to or greater than a threshold. When the difference value derived from the comparison result is equal to or greater than the threshold, the terminal may transmit a measurement report to the base station. The base station may configure the terminal, through the measurement configuration information or report configuration information, to perform measurement upon reception of the measurement trigger and to transmit a measurement report to the base station based on a comparison between signal strength measurement results and signal strength measurement prediction results. The measurement configuration information or the report configuration information may include a threshold for comparison between signal strength measurement results and signal strength measurement prediction results. The measurement configuration information may include configuration information for configuring the terminal to transmit a measurement report according to comparison between signal strength measurement prediction result and signal strength measurement results based on reception of the measurement trigger.

In another example, the base station may transmit, to the terminal, the measurement trigger including a threshold. The terminal may perform measurement after receiving the measurement trigger. The terminal may compare signal strength measurement results with the signal strength measurement prediction results included in the measurement trigger. The terminal may determine whether a difference value of a comparison result is within the threshold. When the difference value is within the threshold, the measurement report transmitted from the terminal to the base station may not include the signal strength measurement results. When the difference value is within the threshold, the measurement report may include a flag indicating that the difference between the signal strength measurement results and the signal strength measurement prediction results is within the threshold. As metrics used to derive the difference value, a mean absolute error (MAE), mean absolute percentage error (MAPE), mean squared error (MSE), or root mean squared error (RMSE) may be considered.

The measurement report may include location information of the terminal according to configuration of the base station (e.g. measurement configuration information). The above-described measurement reporting procedure may be applied not only to the L3 cell-level signal strength measurement and reporting procedure but also to the L1 beam-level signal strength measurement and reporting procedure.

### [Verification Method of Signal Strength Measurement Prediction Results]

A network (e.g. a base station or OAM) may predict signal strength measurement results associated not only with an inter-frequency measurement and an inter-RAT measurement but also with an intra-frequency measurement. The accuracy of signal strength measurement prediction results generated by the network may need to be verified. The above-described accuracy may be verified through comparison between signal strength measurement prediction results generated by the network (hereinafter, ‘network signal strength measurement prediction results’) and signal strength measurement prediction results generated by a terminal (hereinafter, ‘terminal signal strength measurement prediction results’) and/or through comparison between the network signal strength measurement prediction results and signal strength measurement results generated by the terminal (hereinafter, ‘terminal signal strength measurement results’). The base station may perform control for reporting of measurement results and/or reporting of measurement prediction results of the terminal based on the signal strength measurement prediction results.

The base station may determine whether comparison between the network signal strength measurement prediction results and the terminal signal strength measurement results and/or comparison between the network signal strength measurement prediction results and the terminal signal strength measurement prediction results is required. In other words, the base station may determine whether accuracy of the network signal strength measurement prediction results needs to be verified. When the base station determines that the accuracy of the network signal strength measurement prediction results needs to be verified, the base station may transmit a measurement report trigger to the terminal. The base station may request, through the measurement report trigger, the terminal signal strength measurement results and/or the terminal signal strength measurement prediction results from the terminal. The measurement report trigger may be transmitted through DCI, MAC CE, or an RRC message.

The measurement report trigger may include a measurement identifier. In another example, the measurement report trigger may include a measurement object identifier and/or a report configuration identifier. The measurement identifier, the measurement object identifier, or the report configuration identifier may be configured by the measurement configuration information included in the RRC reconfiguration message. The measurement report trigger may include the network signal strength measurement prediction results. The measurement report trigger may include information on neighboring cells for which signal strength measurement results are required.

Upon receiving the measurement report trigger, the terminal may transmit, to the base station, a measurement report including at least one of the terminal signal strength measurement results or the terminal signal strength measurement prediction results. The measurement report may be transmitted through an RRC message, MAC CE, or UCI. The measurement report may include a measurement identifier. In another example, the measurement report may include a measurement object identifier and/or a report configuration identifier. The measurement object identifier and the report configuration identifier may be configured by the measurement configuration information included in the RRC reconfiguration message.

The measurement report trigger may include information on neighboring cells for which signal strength measurement results are required. When the measurement report trigger includes information on neighboring cells for which signal strength measurement results are required, the terminal may transmit, to the base station, a measurement report including signal strength measurement results of the neighboring cells for which signal strength measurement results are required and/or signal strength measurement prediction results of the neighboring cells for which signal strength measurement results are required. The base station may configure the terminal, through the measurement configuration information, to transmit a measurement report when the terminal receives the measurement report trigger. Configuration information for configuring the terminal to transmit the measurement report when the terminal receives the measurement report trigger may be included in report configuration information.

In one example, after receiving the measurement report trigger, the terminal may compare the network signal strength measurement prediction results included in the measurement report trigger with the terminal signal strength measurement results. The terminal may determine whether a difference value between the network signal strength measurement prediction results and the terminal signal strength measurement results is equal to or greater than a threshold. When the difference value between the network signal strength measurement prediction results and the terminal signal strength measurement results is equal to or greater than the threshold, the terminal may transmit, to the base station, a measurement report including the terminal signal strength measurement results and/or the terminal signal strength measurement prediction results.

In another example, after receiving the measurement report trigger, the terminal may compare the network signal strength measurement prediction results included in the measurement report trigger with the terminal signal strength measurement prediction results. The terminal may determine whether a difference value between the network signal strength measurement prediction results and the terminal signal strength measurement prediction results is equal to or greater than a threshold. When the difference value between the network signal strength measurement prediction results and the terminal signal strength measurement prediction results is equal to or greater than the threshold, the terminal may transmit, to the base station, a measurement report including the terminal signal strength measurement results and/or the terminal signal strength measurement prediction results.

The measurement configuration information may include the threshold for comparison between the network signal strength measurement prediction results and the terminal signal strength measurement results or for comparison between the network signal strength measurement prediction results and the terminal signal strength measurement prediction results. The above-described threshold may be included in report configuration information.

In another example, the base station may transmit, to the terminal, a measurement report trigger including the above-described threshold. The terminal that receives the measurement report trigger may compare the terminal signal strength measurement results or the terminal signal strength measurement prediction results with the threshold included in the measurement report trigger. The terminal may determine whether a difference value derived from a comparison result is within the threshold. When the difference value derived from the comparison result is within the threshold, the terminal may transmit, to the base station, a measurement report not including the signal strength measurement results or the signal strength measurement prediction results. The measurement report may include a flag indicating that the difference value derived from the comparison result is within the threshold. As metrics used to derive the difference value, MAE, MAPE, MSE, or RMSE may be considered.

The measurement report may include a location of the terminal according to configuration of the base station. The above-described measurement reporting procedure may be applied not only to the L3 cell-level signal strength measurement and reporting procedure but also to the L1 beam-level signal strength measurement and reporting procedure.

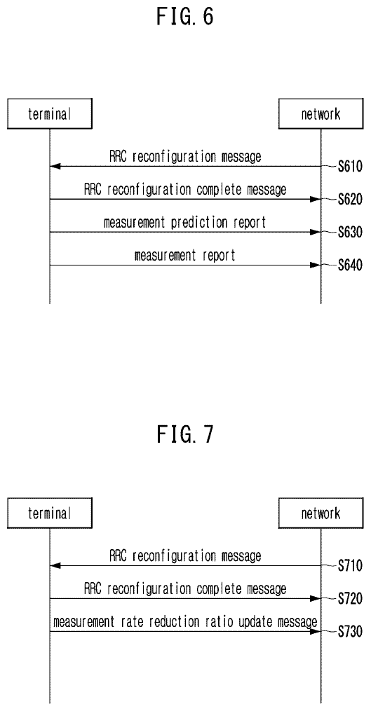

FIG. 6 is a sequence diagram illustrating exemplary embodiments of a measurement prediction reporting procedure.

Referring to FIG. 6, a network (e.g. a base station) may determine measurement configuration information based on capability information of a terminal. The base station may transmit, to the terminal, an RRC reconfiguration message including the measurement configuration information (S610). After receiving the RRC reconfiguration message, the terminal may perform measurement configuration according to the measurement configuration information. After completing the measurement configuration, the terminal may transmit an RRC reconfiguration complete message to the base station (S620). The terminal may periodically perform signal strength measurement on a serving cell and neighboring cells according to the measurement configuration information.

The network (or the base station) may determine measurement prediction configuration information based on capability of the terminal. The base station may transmit, to the terminal, an RRC reconfiguration message including the measurement prediction configuration information. In another example, the measurement configuration information may include a flag indicating that the measurement configuration information is configuration information for measurement prediction. In other words, the measurement configuration information may include the measurement prediction configuration information. After receiving the RRC reconfiguration message, the terminal may perform measurement prediction configuration. The terminal that completes the measurement prediction configuration may transmit an RRC reconfiguration complete message to the base station. The terminal may perform measurement prediction on the serving cell and neighboring cells according to the measurement prediction configuration information. Measurement prediction on the serving cell and the neighboring cells may include predicting signal strength measurement results of signals received from the serving cell or the neighboring cells. The predicted signal strength measurement results may be referred to as signal strength measurement prediction results.

The measurement configuration information and the measurement prediction configuration information may be included in the same RRC message. In another example, the measurement configuration information and the measurement prediction configuration information may be included in different RRC reconfiguration messages.

The terminal may predict, based on the signal strength measurement prediction results, that a first event occurs at a first time. The terminal may transmit, to the base station, a measurement prediction report including signal strength measurement prediction results for neighboring cells for which the first event is predicted to occur at the first time (S630). In another example, the terminal may determine that a first event occurs at a first time. The terminal may transmit, to the base station, a measurement prediction report including signal strength measurement prediction results corresponding to the first time. The signal strength measurement prediction results may be transmitted through a measurement report including a flag indicating that the signal strength measurement prediction results are included.

The measurement prediction report may be transmitted through an RRC message, a MAC CE, or UCI. The measurement prediction report may include a measurement identifier. In another example, the measurement prediction report may include a measurement object identifier or a report configuration identifier. The measurement identifier, the measurement object identifier, and the report configuration identifier may be configured by the measurement prediction configuration information included in the RRC reconfiguration message.

The measurement prediction configuration information may include information on neighboring cells on which the signal strength measurement prediction results included in the measurement prediction report are based. The information on neighboring cells may be included in cluster configuration information. In other words, neighboring cells may be defined in units of a cluster. A cluster may include a serving cell and one or more neighboring cells. The information on neighboring cells or the cluster configuration information including the information on neighboring cells may be included in report configuration information or an information element indicating measurement objects.

The base station may configure the terminal, through the measurement prediction configuration information, to transmit a measurement prediction report when a first event occurs at a first time. Configuration information for configuring the terminal to transmit a measurement prediction report when a first event occurs at a first time through the measurement prediction configuration information may be included in report configuration information. The measurement prediction report may include signal strength measurement prediction results for neighboring cells for which the first event is predicted to occur at the first time. The signal strength measurement prediction results may correspond to signal strength measurement results at the first time at which the first event is predicted to occur. The measurement prediction report may include signal strength measurement results for the above-described neighboring cells at a time at which the measurement prediction report is transmitted (hereinafter referred to as a ‘current time’). The current time may precede the first time at which the first event is predicted to occur. The measurement prediction report may include a signal strength measurement result for the serving cell at the current time. The measurement prediction report may include information on the first time at which the first event is predicted to occur.

The terminal may transmit, to the base station, a measurement report including signal strength measurement results at the first time after transmitting the measurement prediction report (S640). In addition, the terminal may determine whether a first event occurs based on the signal strength measurement results. When the first event occurs, the terminal may transmit, to the base station, a measurement report including the signal strength measurement results. The measurement report may be transmitted through an RRC message, a MAC CE, or UCI. The measurement report may include a measurement identifier. In another example, the measurement report may include a measurement object identifier or a report configuration identifier. The measurement identifier, the measurement object identifier, or the report configuration identifier may be configured by the measurement configuration information included in the RRC reconfiguration message.

The measurement prediction configuration information may include information on neighboring cells associated with the signal strength measurement prediction results included in the measurement report. The information on neighboring cells may be included in cluster configuration information. In other words, the neighboring cells may be defined in units of a cluster. A cluster may include a serving cell and one or more neighboring cells. The information on neighboring cells or the cluster configuration information including the information on neighboring cells may be included in report configuration information or an information element indicating measurement objects.

The base station may configure the terminal, through the measurement configuration information or measurement prediction configuration information, to transmit a measurement report including signal strength measurement results at a first time after transmitting a measurement prediction report to the base station based on prediction that a first event occurs at the first time. Configuration information for configuring the terminal to transmit a measurement report including the signal strength measurement results at the first time after transmitting a measurement prediction report to the base station based on prediction that a first event occurs at the first time may be included in report configuration information.

The measurement report may include signal strength measurement results for a serving cell for which a first event is predicted to occur. The terminal may store the first time at which the first event is predicted to occur. The terminal may trigger a measurement report at the stored time. In another example, the terminal may configure a timer that expires at the time at which the first event is predicted to occur. When the timer expires, the terminal may trigger a measurement report. The terminal may determine, according to configuration of the base station, whether a remaining time-to-trigger (TTT) of a first event predicted by the terminal is equal to or greater than a threshold. When the remaining TTT of the predicted first event is equal to or greater than the threshold, the terminal may trigger a measurement report. For example, the TTT configured for the first event may be 480 msec. The threshold may be 160 msec. The terminal may determine that a remaining TTT of the first event is 80 msec based on the signal strength measurement prediction of the terminal. Since the remaining TTT is not equal to or greater than 160 msec, the terminal may not trigger a measurement report.

The measurement report may include a location of the terminal according to configuration of the base station. The above-described measurement reporting procedure may be applied not only to the L3 cell-level signal strength measurement and reporting procedure but also to the L1 beam-level signal strength measurement and reporting procedure.

FIG. 7 is a sequence diagram illustrating exemplary embodiments of a measurement rate reduction ratio update request procedure.

Referring to FIG. 7, a base station may determine measurement configuration information based on capability information of a terminal. The base station may transmit, to the terminal, an RRC reconfiguration message including the measurement configuration information (S710). After receiving the RRC reconfiguration message, the terminal may perform measurement configuration according to the measurement configuration information. The terminal may periodically perform signal strength measurement for a serving cell and neighboring cells according to the measurement configuration.

The base station may determine measurement prediction configuration information based on capability information of the terminal. The base station may transmit, to the terminal, an RRC reconfiguration message including the measurement prediction configuration information. In another example, the measurement configuration information may include a flag indicating that the measurement configuration information is configuration information for measurement prediction. After receiving the RRC reconfiguration message, the terminal may perform measurement prediction configuration. The terminal that completes the measurement prediction configuration may transmit, to the base station, an RRC reconfiguration complete message (S720). The terminal may predict signal strength measurement results for the serving cell and neighboring cells according to the measurement prediction configuration. The measurement configuration information and the measurement prediction configuration information may be included in the same RRC message. In another example, the measurement configuration information and the measurement prediction configuration information may be included in different RRC reconfiguration messages. The measurement configuration information may include the measurement prediction configuration information.

The measurement prediction configuration information may include control information for controlling signal strength measurement. For example, the terminal may predict inter-frequency measurement. The prediction accuracy of inter-frequency measurement may be high. When the prediction accuracy of inter-frequency measurement is high, communication may not be problematic even when a rate at which inter-frequency measurement is performed is reduced. In another example, the terminal may predict signal strength measurement results corresponding to a first time. When the prediction accuracy of signal strength measurement results of the terminal is high, communication may not be problematic even if a signal strength measurement rate is reduced.

The measurement prediction configuration information may include measurement rate change information that is control information for adjusting the signal strength measurement rate. The measurement rate change information may include a measurement identifier. In another example, the measurement rate change information may include a measurement object identifier or a report configuration identifier. The measurement identifier, the measurement object identifier, or the report configuration identifier may be preconfigured by the measurement configuration information included in the RRC reconfiguration message.

The measurement prediction configuration information may include measurement rate reduction ratio information. The measurement rate reduction ratio information may indicate a ratio by which a rate at which signal strength measurement is performed (hereinafter referred to as a ‘signal strength measurement rate’) is reduced (hereinafter referred to as a ‘measurement rate reduction ratio’). The measurement rate reduction ratio information may indicate a candidate array including one or more measurement rate reduction ratios (hereinafter referred to as a ‘measurement rate reduction ratio candidate array’). The measurement rate reduction ratio may be one of values included in the measurement rate reduction ratio candidate array. In one example, the measurement rate reduction ratio candidate array may be configured as [0.0, 0.25, 0.5, 0.66, 0.75, 0.8, or 1]. When the measurement rate reduction ratio is 1, signal strength measurement may not be performed. When the measurement rate reduction ratio is 0, the signal strength measurement rate may not be reduced.

The measurement prediction configuration information may include initial measurement rate reduction ratio information. The initial measurement rate reduction ratio information may indicate an initial signal strength measurement rate reduction ratio. The initial measurement rate reduction ratio information may be one of information elements included in the measurement rate change information. After receiving the measurement prediction configuration information, the terminal may determine, as a measurement rate reduction ratio, a value indicated by the initial measurement rate reduction ratio information. In another example, an initial measurement rate reduction ratio may be preconfigured in the terminal.

The measurement prediction configuration information may include at least one of Error_MRR_Up, N_MRR_Up, Error_MRR_Down, N_MRR_Down, or N_MRR_Reset. N_MRR_Up, N_MRR_Down, and N_MRR_Reset may be thresholds. The terminal may perform comparison between signal strength measurement results and signal strength measurement prediction results. Based on a difference value derived through the comparison, the terminal may increase one of MRR_Up, MRR_Down, or MRR_UpDown by 1. In other words, the terminal may determine accuracy of the signal strength measurement prediction results through counters. The terminal may determine whether to change the measurement rate reduction ratio through the counters. The difference value may be derived by one of MAE, MAPE, MSE, or RMSE. The terminal may determine whether to change the measurement rate reduction ratio based on value(s) of MRR_Up, MRR_Down, and MRR_UpDown. In other words, the terminal may determine whether to change the measurement rate reduction ratio preconfigured in the terminal based on the measurement rate reduction ratio information. In another example, the terminal may determine whether to change the initial measurement rate reduction ratio preconfigured in the terminal (or the initial measurement rate reduction ratio preconfigured in the terminal) based on the measurement rate reduction ratio information.

In one example, the terminal may determine a difference value by performing comparison between the signal strength measurement results and the signal strength measurement prediction results. The signal strength prediction result may be derived by the terminal. The signal strength measurement results or the signal strength measurement prediction results may be signal strength measurement results or signal strength measurement prediction results for the serving cell or neighboring cells of the terminal. When the difference value is greater than Error_MRR_Down, the terminal may increase MRR_Down by 1. In other words, the signal strength measurement prediction results may not be accurate.

In another example, the terminal may determine a difference value by performing comparison between the signal strength measurement results and the signal strength measurement prediction results. When the difference value is less than Error_MRR_Up, the terminal may increase MRR_Up by 1. In other words, the signal strength measurement prediction results may be accurate.

In another example, the terminal may determine a difference value by performing comparison between the signal strength measurement results and the signal strength measurement prediction results. When the difference value is equal to or greater than Error_MRR_Up and equal to or less than Error_MRR_Down, the terminal may increase MRR_UpDown by 1. In other words, accuracy of the signal strength measurement prediction results may be uncertain. Each time the terminal performs comparison, one of MRR_Up, MRR_Down, or MRR_UpDown may increase by 1.

The terminal may determine to change the measurement rate reduction ratio when the counter increases consecutively. In one example, MRR_Up may increase consecutively N_MRR_Up times. N_MRR_Up may be 1. In other words, during recent N_MRR_Up times, the signal strength measurement prediction results may be accurate. Accordingly, the terminal may determine to increase the measurement rate reduction ratio. For example, the measurement rate reduction ratio may increase from 0.5 to 0.66. MRR_Up may be reset.

In another example, MRR_Down may increase consecutively N_MRR_Down times. N_MRR_Down may be 1. In other words, during the most recent N_MRR_Down instances, the signal strength measurement prediction results may not be accurate. Accordingly, the terminal may determine to decrease the measurement rate reduction ratio. For example, the measurement rate reduction ratio may decrease from 0.75 to 0.66. MRR_Down may be reset.

In another example, MRR_UpDown may increase consecutively N_MRR_Reset times. In other words, during the most recent N_MRR_Reset instances, the signal strength measurement prediction results may be difficult to evaluate. Accordingly, the terminal may reset MRR_Up and MRR_Down to 0. N_MRR_Reset may be 1. In other words, the terminal may reset accumulated counters user to determine whether to increase or decrease the measurement rate reduction ratio.

When the terminal determines to change the measurement rate reduction ratio according to the above-described procedure, the terminal may transmit a measurement rate reduction ratio update message to the base station (S730). The measurement rate reduction ratio update message may include a changed measurement rate reduction ratio. The measurement rate reduction ratio update message may be transmitted through a MAC CE, an RRC message, or UCI. The measurement rate reduction ratio update message may include a measurement identifier. In another example, the measurement rate reduction ratio update message may include a measurement object identifier or a report configuration identifier. The measurement identifier, the measurement object identifier, or the report configuration identifier may be configured by the measurement rate change information included in the RRC reconfiguration message. When the base station determines that the measurement rate reduction ratio is changed through the measurement rate change information, the base station may configure the terminal to transmit a measurement rate reduction ratio update message. Configuration information for configuring the terminal to transmit the measurement rate reduction ratio update message when the measurement rate reduction ratio is determined to be changed may be included in report configuration information.

The above-described measurement prediction-based measurement control method may be applied to the frequency domain, the time domain, or the spatial domain. The above-described measurement prediction-based measurement control method may be applied to inter-RAT measurement prediction.

The above-described measurement prediction-based measurement control method may be applied not only to the L3 cell-level signal strength measurement and reporting procedure but also to the L1 beam-level signal strength measurement and reporting procedure.

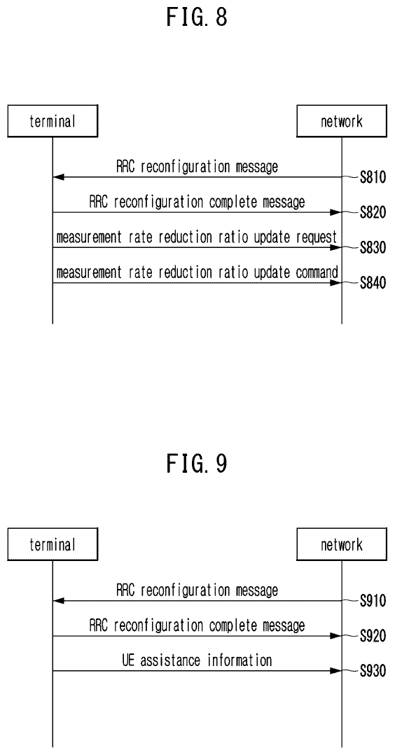

FIG. 8 is a sequence diagram illustrating exemplary embodiments of a measurement rate reduction ratio update procedure.

Referring to FIG. 8, a base station may determine measurement configuration information based on capability information of a terminal. The base station may transmit, to the terminal, an RRC reconfiguration message including the measurement configuration information (S810). After receiving the RRC reconfiguration message, the terminal may perform measurement configuration. After performing the measurement configuration, the terminal may transmit an RRC reconfiguration complete message (S820). The terminal may periodically perform signal strength measurement for a serving cell and neighboring cells according to the measurement configuration.

The base station may determine measurement prediction configuration information based on capability information of the terminal. The base station may transmit, to the terminal, an RRC reconfiguration message including the measurement prediction configuration information. In another example, the measurement configuration information may include a flag indicating that the measurement configuration information is configuration information for measurement prediction. After receiving the RRC reconfiguration message, the terminal may perform measurement prediction configuration. The terminal that completes the measurement prediction configuration may transmit an RRC reconfiguration complete message to the base station. The terminal may perform measurement prediction for the serving cell and neighboring cells according to the measurement prediction configuration information. In another example, the measurement configuration information and the measurement prediction configuration information may be included in different RRC reconfiguration messages. The measurement configuration information may include the measurement prediction configuration information.

The measurement prediction configuration information may include control information for controlling signal strength measurement. For example, the terminal may predict inter-frequency measurement. The prediction accuracy of inter-frequency measurement may be high. When the prediction accuracy of inter-frequency measurement is high, communication may not be problematic even if a rate of inter-frequency measurement is reduced. In another example, the terminal may predict signal strength measurement results corresponding to a first time. When the prediction accuracy of signal strength measurement results of the terminal is high, communication may not be problematic even if a signal strength measurement rate is reduced.

The measurement prediction configuration information may include measurement rate change information that is control information for adjusting the signal strength measurement rate. The measurement rate change information may include a measurement identifier. In another example, the measurement rate change information may include a measurement object identifier or a report configuration identifier. The measurement identifier, the measurement object identifier, or the report configuration identifier may be preconfigured by the measurement configuration information included in the RRC reconfiguration message.

The measurement prediction configuration information may include measurement rate reduction ratio information. The measurement rate reduction ratio information may indicate a ratio by which a rate at which signal strength measurement is performed (hereinafter, ‘signal strength measurement rate’) is reduced (hereinafter, ‘measurement rate reduction ratio’). The measurement rate reduction ratio may be one of values included in a candidate array including one or more measurement rate reduction ratios (hereinafter, ‘measurement rate reduction ratio candidate array’). In one example, the measurement rate reduction ratio candidate array may be configured as [0.0, 0.25, 0.5, 0.66, 0.75, 0.8, or 1]. When the measurement rate reduction ratio is 1, the signal strength measurement may not be performed. When the measurement rate reduction ratio is 0, the signal strength measurement rate may not be reduced.

The measurement prediction configuration information may include initial measurement rate reduction ratio information. The initial measurement rate reduction ratio information may indicate an initial signal strength measurement rate reduction ratio. The initial measurement rate reduction ratio information may be one of information elements included the in measurement rate change information. After receiving the measurement prediction configuration information, the terminal may determine a value indicated by the initial measurement rate reduction ratio information as the measurement rate reduction ratio. In another example, the initial measurement rate reduction ratio may be preconfigured in the terminal.

The measurement prediction configuration information may include at least one of Error_MRR_Up, N_MRR_Up, Error_MRR_Down, N_MRR_Down, or N_MRR_Reset. N_MRR_Up, N_MRR_Down, and N_MRR_Reset may be thresholds. The terminal may perform a comparison between signal strength measurement results and signal strength measurement prediction results. The terminal may increase one of MRR_Up, MRR_Down, or MRR_UpDown by 1 based on a difference value derived from the comparison. In other words, the terminal may determine accuracy of the signal strength measurement prediction results through the counters. The terminal may determine whether the measurement rate reduction ratio needs to be changed through the counters. The difference value may correspond to one of MAE, MAPE, MSE, or RMSE. The terminal may determine whether the measurement rate reduction ratio needs to be changed based on values of MRR_Up, MRR_Down, and MRR_UpDown. In other words, the terminal may determine whether the measurement rate reduction ratio preconfigured in the terminal needs to be changed based on the measurement rate reduction ratio information. In another example, the terminal may determine whether the initial measurement rate reduction ratio preconfigured in the terminal needs to be changed based on the measurement rate reduction ratio information.

In one example, the terminal may perform a comparison between signal strength measurement results and signal strength measurement prediction results to determine a difference value. The signal strength measurement prediction results may be derived by the terminal. The signal strength measurement results or the signal strength measurement prediction results may be signal strength measurement results or signal strength measurement prediction results for the serving cell of the terminal or for neighboring cells. When the difference value is greater than Error_MRR_Down, the terminal may increase MRR_Down by 1. In other words, the signal strength measurement prediction results may not be accurate.

In another example, the terminal may perform a comparison between signal strength measurement results and signal strength measurement prediction results to determine a difference value. When the difference value is less than Error_MRR_Up, the terminal may increase MRR_Up by 1. In other words, the signal strength measurement prediction results may be accurate.

In another example, the terminal may perform a comparison between signal strength measurement results and signal strength measurement prediction results to determine a difference value. When the difference value is equal to or greater than Error_MRR_Up and equal to or less than Error_MRR_Down, the terminal may increase MRR_UpDown by 1. In other words, accuracy of the signal strength measurement prediction results may not be certain. Each time the terminal performs the comparison, one of MRR_Up, MRR_Down, or MRR_UpDown may increase by 1.

The terminal may determine to change the measurement rate reduction ratio when the counter increases consecutively. In one example, MRR_Up may increase consecutively N_MRR_Up times. N_MRR_Up may be 1. In other words, during the most recent N_MRR_Up instances, the signal strength measurement prediction results may be accurate. Accordingly, the terminal may determine that an increase of the measurement rate reduction ratio is required. For example, the terminal may determine that the measurement rate reduction ratio needs to increase from 0.5 to 0.66. MRR_Up may be reset.

In another example, MRR_Down may increase consecutively N_MRR_Down times. N_MRR_Down may be 1. In other words, during the most recent N_MRR_Down instances, the signal strength measurement prediction results may not be accurate. Accordingly, the terminal may determine that a decrease of the measurement rate reduction ratio is required. For example, the terminal may determine that the measurement rate reduction ratio needs to decrease from 0.75 to 0.66. MRR_Down may be reset.

In another example, MRR_UpDown may increase consecutively N_MRR_Reset times. In other words, during the most recent N_MRR_Reset instances, accuracy of the signal strength measurement prediction results may be difficult to evaluate. Accordingly, the terminal may reset MRR_Up and MRR_Down to 0. N_MRR_Reset may be 1. In other words, the terminal may reset accumulated counters used to determine whether to increase or decrease the measurement rate reduction ratio.

When the terminal determines that a change of the measurement rate reduction ratio is required according to the above-described procedure, the terminal may transmit, to the base station, a measurement rate reduction ratio update request (hereinafter, ‘update request’) indicating that the change of the measurement rate reduction ratio is required (S830). In other words, the update request may include information indicating increase or decrease of the measurement rate reduction ratio configured in the terminal. The update request may be transmitted through a MAC CE, an RRC message, or UCI. The update request may include a measurement identifier. In another example, the measurement rate reduction ratio update message may include a measurement object identifier or a report configuration identifier. The measurement identifier, the measurement object identifier, or the report configuration identifier may be configured by the measurement rate change information included in the RRC reconfiguration message. The base station may configure the terminal, through the measurement rate change information, to transmit the update request when it is determined that a change of the measurement rate reduction ratio is required. Configuration information for configuring the terminal to transmit the update request when it is determined that a change of the measurement rate reduction ratio is required through the measurement rate change information may be included in report configuration information. The update request may indicate either that an increase of the measurement rate reduction ratio is required or that a decrease of the measurement rate reduction ratio is required.

Upon receiving the update request, the base station may change the measurement rate reduction ratio. The base station may transmit, to the terminal, a measurement rate reduction ratio update command (hereinafter, ‘update command’) including a changed measurement rate reduction ratio (S840). The update command may be transmitted as one of a MAC CE, an RRC message, or DCI. The update command may include a measurement identifier. In another example, the update command may include a measurement object identifier or a report configuration identifier. The measurement identifier, the measurement object identifier, or the report configuration identifier may be configured by the measurement rate change information.

The update command may include information indicating increase or decrease in the measurement rate reduction ratio. The update command may include information indicating a degree by which the measurement rate reduction ratio is increased or information indicating a degree by which the measurement rate reduction ratio is decreased. The update command may include information indicating a number of steps by which the measurement rate reduction ratio is decreased or information indicating a number of steps by which the measurement rate reduction ratio is increased. In other words, the update command may include a difference between an index of a first measurement rate reduction ratio configured in the terminal within the candidate array and an index of a second measurement rate reduction ratio changed based on the update request within the candidate array. For example, the measurement rate reduction ratio candidate array may be [0.0, 0.25, 0.5, 0.66, 0.75, 0.8, 1.0]. A currently configured measurement rate reduction ratio may be 0.5. After receiving the update command, the terminal may identify from the update command that a number of steps by which the measurement rate reduction ratio is increased is 2. The terminal may (re) set the measurement rate reduction ratio to 0.75. After receiving the update command, the terminal may reset MRR_Up and MRR_Down to 0.

The above-described network-based measurement control method may be applied to the frequency domain, temporal domain, or spatial domain. The above-described network-based measurement control method may be applied also to inter-RAT measurement prediction.

The above-described network-based measurement control method may be applied not only to the L3 cell-level signal strength measurement and reporting procedure but also to the L1 beam-level signal strength measurement and reporting procedure.

FIG. 9 is a sequence diagram illustrating exemplary embodiments of a UE assistance information transmission procedure.

Referring to FIG. 9, a base station may determine inference parameter information based on capability of a terminal. The base station may transmit, to the terminal, inference configuration information including the inference parameter information through an RRC reconfiguration message (S910). The inference parameter information may be transmitted through an inferenceConfig or otherConfig information element. The terminal that receives the inference configuration information may transmit, to the base station, an RRC reconfiguration complete message (S920). When inference preference configuration information is included in the inference configuration information, the terminal may confirm that the terminal is configured to report, through UE assistance information, inference parameters preferred by the terminal for a terminal-side inference function. The reporting of inference parameters preferred by the terminal for a terminal-side inference function to the base station may be referred to as inference parameter preference reporting.

When the inference parameter preference reporting is configured, the terminal may transmit a preference for inference parameters to the base station. When the preference for the inference parameters is changed, the terminal may transmit the preference for the inference parameters to the base station. In order to prevent frequent reporting, a timer may be configured in the terminal. While the timer is running, the preference for the inference parameters may not be reported to the base station.

The terminal may transmit, to the base station, UE assistance information including preferred inference parameter information including the inference parameter(s) preferred by the terminal among inference parameters indicated by the inference parameter information (S930).

In one example, inference configuration information associated with RRM measurement prediction may include inference parameters (e.g. a prediction window length or a measurement reduction pattern). When the inference configuration information includes inference preference configuration information associated with the RRM measurement prediction, the terminal may confirm that inference parameter preference reporting associated with the RRM measurement prediction is configured. When the inference parameter preference reporting is configured, the terminal may report, to the base station, a preference for inference parameters associated with the RRM measurement prediction. When the preference for the inference parameters is changed, the terminal may transmit, to the base station, the preference for the inference parameters associated with the RRM measurement prediction. In order to prevent frequent reporting, a timer may be configured in the terminal. While the timer is running, the preference for the inference parameters may not be reported to the base station.

The terminal may determine inference parameters preferred by the terminal with respect to the inference parameters indicated by the inference parameter information. The terminal may transmit, to the base station, UE assistance information including preferred inference parameter information including the determined inference parameters. For example, a prediction window length may be set to 320 ms in the terminal by the inference configuration information. When a channel condition changes rapidly, the terminal may determine 160 ms as a preferred prediction window length. The terminal may transmit, to the base station, UE assistance information including preferred inference parameter information including the prediction window length set to 160 ms. In another example, a measurement reduction pattern having a measurement reduction rate in temporal domain (MRRT) of 50% may be configured in the terminal by the inference configuration information. When a channel condition changes rapidly, the terminal may determine 25% as a preferred MRRT. The terminal may transmit, to the base station, UE assistance information including preferred inference parameter information including a measurement reduction pattern having an MRRT of 25%. The terminal may adjust the MRRT according to channel variation to maintain an RRM measurement prediction error to be equal to or less than a predetermined level.

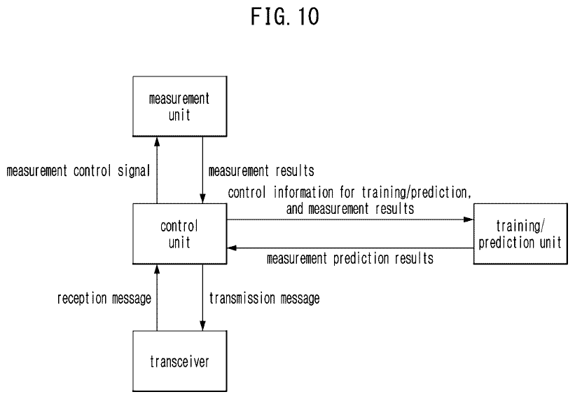

FIG. 10 is a conceptual diagram illustrating exemplary embodiments of functional blocks included in a terminal.

Referring to FIG. 10, functional blocks included in a terminal performing measurement reporting and/or measurement prediction reporting may be identified. The functional blocks may be configured to perform measurement reporting and/or measurement prediction reporting by the terminal. Roles of the respective functional blocks are described below.

A transceiver may deliver a message received from a base station (e.g. RRC reconfiguration message) to a control unit. The control unit may deliver measurement control information (e.g. measurement configuration information) to a measurement unit according to an instruction of the received message. Alternatively, the control unit may deliver measurement control information included in the received message to the measurement unit. The measurement unit may perform measurement on a serving cell and/or neighboring cell(s) according to the measurement control information. Through measurement on the serving cell and/or neighboring cell(s), the measurement unit may generate measurement results. The measurement unit may deliver the measurement results to the control unit. The control unit may deliver the received measurement results and control information for training/prediction (e.g. measurement prediction configuration information) to a training/prediction unit. The training/prediction unit may perform measurement prediction for the serving cel) and/or neighboring cell(s) using the measurement results according to the control information for training/prediction. The training/prediction unit may generate measurement prediction results through measurement prediction for the serving cell and/or neighboring cell(s). The training/prediction unit may deliver the measurement prediction results to the control unit.

The control unit may generate one or more measurement reports and/or one or more measurement prediction reports based on the measurement results and/or the measurement prediction results. The control unit may transmit the one or more measurement reports and/or the one or more measurement prediction reports to the base station. The measurement unit may be responsible for RRM measurement, a radio link monitoring (RLM) process, and a handover process. The training/prediction unit may be responsible for an RRM measurement prediction process, a radio link failure (RLF) prediction process, a prediction process for measurement report events, and a prediction process for measurement prediction report events.

In the present disclosure, signal strength measurement may refer not only to measuring power of a received signal but also to an RRM measurement procedure. In other words, the RRM measurement may be a measurement of at least one of reference signal received power (RSRP), reference signal received quality (RSRQ), or signal to interference plus noise ratio (SINR) for signals received from cells configured in the terminal (e.g. serving cell and neighboring cells). In a practical mobile communication system, a measurement and measurement reporting procedure by a terminal may be performed based on RSRP. In the present disclosure, use of RSRP as an indicator of signal strength measurement may be for convenience of description. Accordingly, in the present disclosure, signal strength measurement may include not only measurement of RSRP but also the RRM measurement.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
receiving measurement configuration information from a base station;
receiving, from the base station, a measurement trigger for cells indicated by the measurement configuration information;
performing measurement on the cells based on the measurement trigger; and
transmitting, to the base station, a measurement report based on the measurement.

2. The method according to claim 1, wherein the measurement trigger includes first information for measurement on the cells, the measurement is performed according to the first information, and the measurement report includes measurement results based on the measurement.

3. The method according to claim 1, wherein the measurement configuration information includes measurement gap configuration information, the measurement gap configuration information includes at least one of a measurement gap repetition period or a measurement gap length, measurement gaps configured by the measurement gap configuration information enter an active state based on reception of the measurement trigger, the measurement is performed during time durations indicated by the measurement gaps, and the measurement gaps enter an inactive state based on completion of the measurement.

4. The method according to claim 1, wherein the measurement configuration information includes configuration information for a cluster including the cells, and the cluster includes at least one of a serving cell of the terminal or neighboring cells of the terminal.

5. The method according to claim 1, wherein the measurement configuration information includes configuration information for configuring the terminal to transmit the measurement report based on reception of the measurement trigger.

6. The method according to claim 1, further comprising: after performing the measurement, performing a comparison between measurement prediction results included in the measurement trigger and measurement results based on the measurement,
wherein the measurement report is transmitted based on the comparison.

7. The method according to claim 1, wherein the measurement configuration information includes configuration information for configuring the terminal to transmit the measurement report based on a comparison between measurement prediction results included in the measurement trigger and measurement results, the comparison being performed based on reception of the measurement trigger.

8. The method according to claim 6, wherein the measurement report is transmitted based on a difference value between the measurement prediction results included in the measurement trigger and the measurement results being equal to or greater than a threshold, and the measurement trigger includes the threshold.

9. The method according to claim 6, wherein the measurement report does not include the measurement results, based on a difference value between the measurement prediction results included in the measurement trigger and the measurement results being equal to or less than a threshold, and the measurement report includes a flag indicating that the difference value is equal to or less than the threshold.

10. The method according to claim 1, wherein the measurement report includes measurement results based on the measurement, and includes location information of the terminal according to the measurement configuration information.

11. A method of a base station, comprising:
transmitting measurement configuration information to a terminal;
performing measurement prediction for cells indicated by the measurement configuration information;
transmitting, to the terminal, a measurement trigger including measurement prediction results based on the measurement prediction; and
receiving, from the terminal, a measurement report in response to the measurement trigger.

12. The method according to claim 11, wherein the measurement trigger includes first information for measurement on the cells, the measurement is performed by the terminal according to the first information, and the measurement report includes measurement results based on the measurement.

13. The method according to claim 11, wherein the measurement configuration information includes configuration information for configuring the terminal to transmit the measurement report based on reception of the measurement trigger.

14. The method according to claim 11, wherein the measurement configuration information includes configuration information for configuring the terminal to transmit the measurement report based on a comparison between the measurement prediction results and measurement results, the comparison being performed based on reception of the measurement trigger.

15. The method according to claim 11, wherein the measurement report is transmitted from the terminal based on a difference value between the measurement prediction results and measurement results based on measurement performed by the terminal being equal to or greater than a threshold, and the measurement trigger includes the threshold.

16. The method according to claim 11, wherein the measurement report does not include measurement results, based on a difference value between the measurement prediction results and measurement results based on measurement performed by the terminal being equal to or less than a threshold, and the measurement report includes a flag indicating that the difference value is equal to or less than the threshold.

17. The method according to claim 11, wherein the measurement configuration information includes configuration information for configuring the terminal to transmit the measurement report according to a comparison between the measurement prediction results and measurement results, the comparison being performed based on reception of the measurement trigger.

18. The method according to claim 11, wherein the measurement report includes measurement results based on measurement performed by the terminal, and includes location information of the terminal according to the measurement configuration information.

19. A terminal comprising at least one processor, wherein the at least one processor causes the terminal to perform:
receiving measurement configuration information from a base station;
receiving, from the base station, a measurement trigger for cells indicated by the measurement configuration information;
performing measurement on the cells based on the measurement trigger; and
transmitting, to the base station, a measurement report based on the measurement.

20. The terminal of claim 19, wherein the measurement trigger includes first information for measurement on the cells, the measurement is performed according to the first information, and the measurement report includes measurement results based on the measurement.
